(19) United States
(12) Patent Application Publication
(10) Pub. No.: US 2025/0354854 A1
(43) Pub. Date: Nov. 20, 2025

(54) PORTABLE SCALE WITH RANGING FUNCTION

(71) Applicant: Junchun Gao, Zhongshan (CN)

(72) Inventor: Junchun Gao, Zhongshan (CN)

(21) Appl. No.: 19/205,599

(22) Filed: May 12, 2025

(30) Foreign Application Priority Data
May 20, 2024 (CN) 202421106018.5

(51) Int. Cl. G01G 21/28; G01S 13/08

(52) U.S. Cl. CPC G01G 21/28; G01S 13/08

(57) ABSTRACT

A portable scale with a ranging function is provided. According to the portable scale, components such as a weighing sensor, a wireless ranging sensor, a sensing button and a level meter are integrated in a housing of the portable scale, which can intelligently identify a weighing mode and a height ranging mode for weighing and ranging of a target. The wireless ranging sensor is used in the portable scale, which effectively avoids an error and inconvenience brought by a traditional contact measurement method and enables ranging to be more accurate. A weighing hook is located below the weighing sensor, which is convenient to weigh a hanging object. The wireless ranging sensor passes through the housing via a first opening to ensure that the wireless ranging sensor faces the target and improve measurement accuracy.

### TECHNICAL FIELD

The present disclosure relates to the technical field of portable scales, and in particular, to a portable scale with a ranging function.

### BACKGROUND

A portable scale, also known as a portable electronic scale, is characterized by being light, thin, short, small and portable, which is not only widely used in industries such as light industry, electronics industry, chemical industry and trade industry, but also plays an important role in a family, the medical field and daily life.

Chinese Patent Application No. CN216621422U discloses a multifunctional portable scale, which includes a housing. A weighing sensor, a tape measure, a weighing hook, a man-machine operation panel and a display are arranged in the housing. One end of the weighing hook passes through the housing. A pull-out end of the tape measure passes through the housing, and is exposed outside the housing and perpendicular to the weighing hook, so that the portable scale can measure both a weight and a size of an object. However, the portable scale uses the tape measure to measure a size of an object, and precision of the tape measure is limited by precision of scale markings and operating skills of measurers, so that it is difficult to meet a requirement of high-precision measurement. In addition, the tape measure may bend during use, which will affect measurement result accuracy and further affect measurement accuracy. Moreover, the tape measure usually has a limited measuring range, and measurement of a long size may require a plurality of superimposed measurement, which increases complexity and uncertainty of measurement. Flexibility influence: In addition, when measuring objects at a high or deep position, use of the tape measure requires an auxiliary tool such as a ladder or a telescopic pole, which increases difficulty and complexity of measurement. At the same time, the portable scale is not provided with a level meter for assisting horizontal calibration, which leads to tilt errors when weighing and ranging in a non-horizontal state, further reduces accuracy of weighing and ranging, and fails to meet an application scenario with a high requirement for measurement accuracy.

### SUMMARY

In order to solve the foregoing problems, the present disclosure provides a portable scale with a ranging function, which can effectively solve shortcomings in the prior art.

The present disclosure is achieved by the following technical scheme. A portable scale with a ranging function is provided, including a housing, wherein a weighing sensor and a wireless ranging sensor are arranged on the housing, a weighing hook located below the weighing sensor is connected to the housing, the housing is provided with a first opening and a second opening, the wireless ranging sensor passes through the housing via the first opening, a display is mounted on the second opening, and at least one group of level meters is mounted at any position outside the housing.

As a preferred technical scheme, the housing is divided into an upper housing portion and a lower housing portion connected to the upper housing portion, the wireless ranging sensor is mounted at a top of the upper housing portion, the first opening is provided on an upper surface of the upper housing portion, the weighing sensor is mounted at a bottom of the lower housing portion, and the at least one group of level meters is mounted in a mounting slot between the upper housing portion and the lower housing portion.

As a preferred technical scheme, the at least one group of level meters includes a first level meter and a second level meter, the mounting slot includes a first mounting slot and a second mounting slot arranged between the upper housing portion and the lower housing portion, the first level meter is mounted in the first mounting slot, the second level meter is mounted in the second mounting slot, and the first level meter is arranged perpendicular to the second level meter.

As a preferred technical scheme, a limit groove into which the weighing hook swings is concavely arranged upwards on an outer wall of a bottom surface of the lower housing portion, a first mounting groove into which the weighing sensor is mounted is convexly formed upwards in the lower housing portion, a plurality of limit convex strips are convexly arranged inwards on an inner wall of the first mounting groove, a first through hole is provided on an upper wall of the limit groove, and one end of the weighing hook passes through the first through hole and is connected to the housing through a nut; a second through hole is further provided at a position, far away from the first through hole, of the upper wall of the limit groove, a sensing button which is configured to sense whether the weighing hook swings into the limit groove is arranged in the lower housing portion, and a sensing portion of the sensing button is mounted at a position of the second through hole.

As a preferred technical scheme, a first PCB (Printed Circuit Board) board is mounted inside the housing, a backlight board and a power button which is configured to control the portable scale to be turned on or off are arranged on the first PCB board, the backlight board is connected below the display, a button protection cover is mounted on the power button, the housing is further provided with a third opening, and a pressing portion of the button protection cover passes through the housing via the third opening.

As a preferred technical scheme, the second opening and the third opening are both provided on an upper surface of the housing, the housing extends downwards around the second opening to form an annular wall, the housing is provided with a plurality of first mounting posts with screw holes on a periphery of the annular wall, the first PCB board is connected to the first mounting posts by a screw, and a first reserved space into which the display and the backlight board swing is formed on an inner periphery of the annular wall.

As a preferred technical scheme, a second PCB board and a plurality of second mounting posts with screw holes are arranged in the upper housing portion, the wireless ranging sensor is connected to the second PCB board, the second PCB board is connected to the second mounting posts by a screw, and the plurality of second mounting posts with screw holes are arranged around the first opening and form a second reserved space into which the wireless ranging sensor swings.

As a preferred technical scheme, a second mounting groove is formed outwards on one side wall of the lower housing portion, a first powerful magnet is mounted in the second mounting groove, a plurality of third mounting grooves are convexly formed upwards on an inner wall of a bottom surface of the lower housing portion, a second powerful magnet is mounted in the third mounting groove, and the third mounting groove is located above the upper wall of the limit groove.

As a preferred technical scheme, the housing is further provided with a battery, and a power supply port is provided on a side wall of the housing.

As a preferred technical scheme, the wireless ranging sensor is an ultrasonic ranging sensor, a radar ranging sensor, an infrared ranging sensor or a laser ranging sensor.

The portable scale of the present disclosure has the following beneficial effects. 1. The portable scale of the present disclosure integrates the weighing sensor and the wireless ranging sensor in the housing, so that the portable scale can be separately used for weighting and ranging of an object. A portable scale which facilitates weighing and ranging is provide to a user. Moreover, the wireless ranging sensor is provided, which avoids possible errors resulted from contact measurement in a traditional ranging tool and can meet the measurement requirements for various precision. The weighing hook is located below the weighing sensor, so that the user can hang an object on the weighing hook for weighing. The wireless ranging sensor passes through the housing via the first opening to directly face the object to be ranged and ensure measurement accuracy. A display is mounted on the second opening, so that a weight and a ranging result of the object can be displayed in real time.

2. According to the present disclosure, the wireless ranging sensor is mounted at a top of the upper housing portion, and the weighing sensor is mounted at a bottom of the lower housing portion. The wireless ranging sensor and the weighing sensor are independently mounted at different positions, so that the wireless ranging sensor and the weighing sensor are arranged at an upper-lower interval without interfering with each other, and measurement accuracy is improved. Furthermore, upper and lower spaces of the housing can be made full use of. In addition, the wireless ranging sensor is mounted at the top of the upper housing portion, so that the user can conveniently adjust the sensor to face the object to be measured when ranging is needed. However, when ranging is not needed, the wireless ranging sensor faces upwards, thereby avoiding unnecessary damage or interference. On the contrary, if the weighing sensor and the wireless ranging sensor are arranged on the same side, the weighing sensor and the wireless ranging sensor may interfere with each other because the two sensors are close in physical position.

3. According to the present disclosure, the limit groove is arranged to store the weighing hook when the weighing function is not needed, which, on the one hand, can save space and protect the weighing hook, and on the other hand, can prevent the hook from shaking when the ranging function is used and affecting the ranging result, so as to ensure measurement accuracy. The first mounting groove and the limit convex strip are arranged, which provides a limit mounting space for the weighing sensor, so as to ensure that the position of the mounted weighing sensor is stable and is not easy to shift, improve mounting precision and reliability, and increase strength of the housing. One end of the weighing hook passes through the first through hole of the upper wall of the limit groove and is connected to the housing through a nut, so that the weighing hook is firmly connected and is not easy to fall off, and accuracy and safety of weighing are ensured.

4. According to the present disclosure, a second through hole is provided in the limit groove, and the sensing button is arranged, so that the sensing button can intelligently sense whether the weighing hook swings into the limit groove, and functions of the portable scale are automatically switched accordingly, which is convenient for a user and improves user experience and use efficiency. Moreover, because the functions are switched based on an actual state of the weighing hook, misoperation of a user can be minimized, and reliability and accuracy of the portable scale are further improved. Moreover, the functions are switched intelligently, so that the portable scale can turn off the weighing function when weighing is not needed, thereby reducing energy consumption and achieving the purposes of saving energy and protecting environment. A photoelectric sensor is used as a sensing button, which can ensure accuracy and rapidity of sensing. At the same time, the photoelectric sensor itself has the advantages of a small size and a fast response, which further improves flexibility of the portable scale. In addition, the second through hole is arranged at a position far away from the first through hole, which can prevent the sensing button from detecting the part where the hook is fixedly connected to the housing and mistakenly thinking that the weighing hook has been placed in the limit groove, thereby improving sensing accuracy and ensuring accuracy of use of the functions of the portable scale.

5. According to the present disclosure, at least one group of level meters is further arranged on the housing. The level meter can assist a user in judging whether the current scale is in a horizontal state. On the one hand, this arrangement can be used to calibrate a measurement attitude, avoid weighing or ranging errors resulted from tilt, and improve measurement accuracy. On the other hand, in the outdoors or in complex terrains, a user can quickly adjust their posture through the level meter without relying on an additional device for leveling, which enhances convenience and applicability of the portable scale. Especially in a scene of measuring large-sized objects or requiring high precision, a level meter is added, which effectively improves reliability of the overall measurement.

### BRIEF DESCRIPTION OF THE DRAWINGS

In order to more clearly explain the technical scheme in the embodiments of the present disclosure or the prior art, the drawings needed to be used in the description of the embodiments or the prior art will be briefly introduced below. Obviously, the drawings in the following description are only some embodiments of the present disclosure. Other drawings can be obtained according to these drawings without paying creative labor for those skilled in the art.

FIG. 1 is a schematic diagram of an exploded structure of a portable scale according to the present disclosure;

FIG. 2 is a schematic structural diagram of a lower housing portion of a housing according to the present disclosure;

FIG. 3 is a schematic structural diagram of an upper housing portion of a housing according to the present disclosure; and

FIG. 4 is a schematic diagram of an exploded structure of a housing and a level meter according to the present disclosure.

### DETAILED DESCRIPTION OF THE EMBODIMENTS

All features disclosed in this specification or all disclosed steps in a method or process can be combined in any way except mutually exclusive features and/or steps.

Any feature disclosed in this specification (including any appended claims, the abstract and drawings) can be replaced by other equivalent or similar substitute features unless otherwise specified. That is, unless otherwise stated, each feature is just one example in a series of equivalent or similar features.

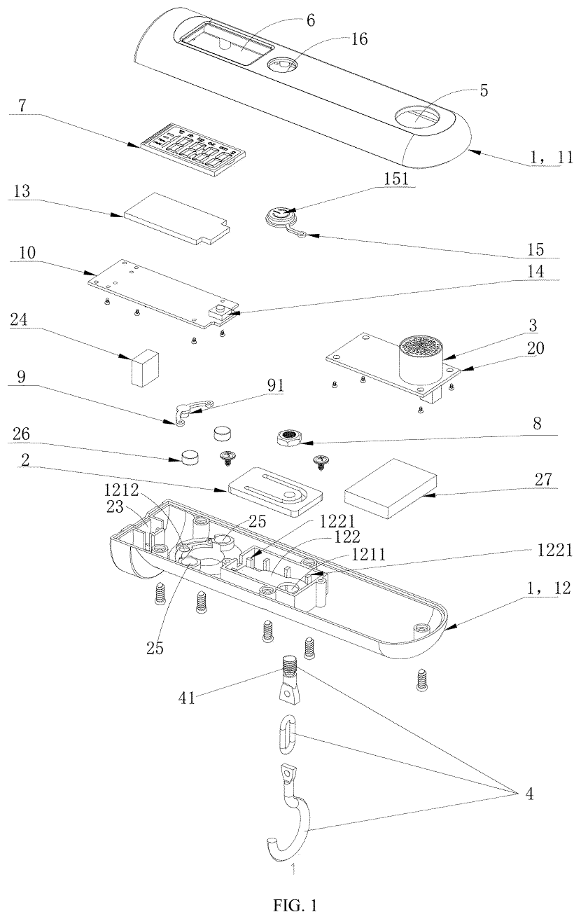

As shown in FIG. 1, a portable scale with a ranging function is provided, including a housing 1. A weighing sensor 2 and a wireless ranging sensor 3 are arranged on the housing 1. A weighing hook 4 located below the weighing sensor 2 is connected to the housing 1. The housing 1 is provided with a first opening 5 and a second opening 6. The wireless ranging sensor 3 passes through the housing 1 via the first opening 5. A display 7 is mounted on the second opening 6. In a specific implementation, the portable scale according to the present disclosure can be used as a luggage scale, such as measuring a weight and a size of a luggage, and is especially suitable for measuring human height in a family. The display 7 may be an OLED (Organic Light-Emitting Diode) display screen or a digital tube.

As mentioned above, the portable scale of the present disclosure integrates the weighing sensor 2 and the wireless ranging sensor 3 in the housing 1, so that the portable scale can be separately used for weighting and ranging of an object. A portable scale which facilitates weighing and ranging is provide to a user. Moreover, the wireless ranging sensor 3 is provided, which avoids possible errors resulted from contact measurement in a traditional ranging tool and can meet the measurement requirements for various precision. The weighing hook 4 is located below the weighing sensor 2, so that the user can hang an object on the weighing hook for weighing. The wireless ranging sensor 3 passes through the housing 1 via the first opening 5 to directly face the object to be ranged and ensure measurement accuracy. A display 7 is mounted on the second opening 6, so that a weight and a ranging result of the object can be displayed in real time.

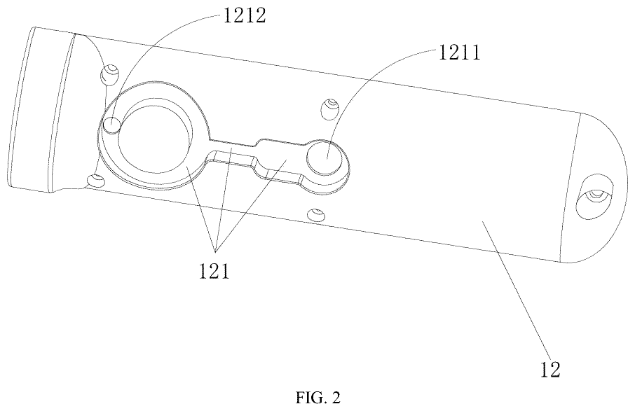

As shown in FIG. 1 and FIG. 2, the housing 1 is divided into an upper housing portion 11 and a lower housing portion 12 connected to the upper housing portion 11. The wireless ranging sensor 3 is mounted at a top of the upper housing portion 11. The first opening 5 is provided on an upper surface of the upper housing portion 11. The weighing sensor 2 is mounted at a bottom of the lower housing portion 12. In a specific implementation, the upper housing portion 11 and the lower housing portion 12 can be engaged together or connected together by a screw. When ranging is needed, the wireless ranging sensor 3 faces the object to be measured. When ranging is not needed, the wireless ranging sensor 3 faces upwards.

As mentioned above, according to the present disclosure, the wireless ranging sensor 3 is mounted at a top of the upper housing portion 11, and the weighing sensor 2 is mounted at a bottom of the lower housing portion 12. The wireless ranging sensor and the weighing sensor are independently mounted at different positions, so that the wireless ranging sensor and the weighing sensor are arranged at an upper-lower interval without interfering with each other, and measurement accuracy is improved. Furthermore, upper and lower spaces of the housing 1 can be made full use of. In addition, the wireless ranging sensor 3 is mounted at the top of the upper housing portion 11, so that the user can conveniently adjust the sensor to face the object to be measured when ranging is needed. However, when ranging is not needed, the wireless ranging sensor 3 faces upwards, thereby avoiding unnecessary damage or interference. On the contrary, if the weighing sensor 2 and the wireless ranging sensor 3 are arranged on the same side, the weighing sensor and the wireless ranging sensor may interfere with each other because the two sensors are close in physical position.

As shown in FIG. 1 and FIG. 2, a limit groove 121 into which the weighing hook 4 swings is concavely arranged upwards on an outer wall of a bottom surface of the lower housing portion 12. A first mounting groove 122 into which the weighing sensor 2 is mounted is convexly formed upwards in the lower housing portion 12. A plurality of limit convex strips 1221 are convexly arranged inwards on an inner wall of the first mounting groove 122. A first through hole 1211 is provided on an upper wall of the limit groove 121. One end of the weighing hook 4 passes through the first through hole 1211 and is connected to the housing 1 through a nut 8. In a specific implementation, one end of the weighing hook 4 is provided with an external thread 41.

As mentioned above, according to the present disclosure, the limit groove 121 is arranged to store the weighing hook 4 when the weighing function is not needed, which, on the one hand, can save space and protect the weighing hook 4, and on the other hand, can prevent the hook from shaking when the ranging function is used and affecting the ranging result, so as to ensure measurement accuracy. The first mounting groove 122 and the limit convex strip 1221 are arranged, which provides a limit mounting space for the weighing sensor 2, so as to ensure that the position of the mounted weighing sensor 2 is stable and is not easy to shift, improve mounting precision and reliability, and increase strength of the housing. One end of the weighing hook 4 passes through the first through hole 1221 of the upper wall of the limit groove 121 and is connected to the housing 1 through a nut 8, so that the weighing hook 4 is firmly connected and is not easy to fall off, and accuracy and safety of weighing are ensured.

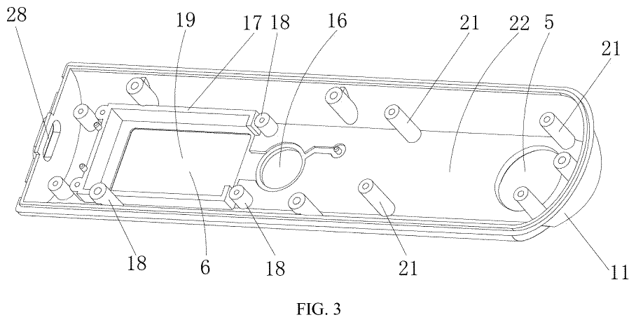

As shown in FIG. 3, a second through hole 1212 is further provided at a position, far away from the first through hole 1211, of the upper wall of the limit groove 121. A sensing button 9 which is configured to sense whether the weighing hook 4 swings into the limit groove 121 is arranged in the lower housing portion 12. A sensing portion 91 of the sensing button 9 is mounted at a position of the second through hole 1212. In a specific implementation, when the sensing button 9 senses that the weighing hook 4 is in the limit groove 121, the portable scale is switched to the ranging function through the circuit. When the sensing button 9 senses that the weighing hook 4 is not in the limit groove 121, that is, the weighing hook 4 is lowered, the portable scale is switched to the weighing function through the circuit, so that the function switching is achieved through the sensing button 9. The sensing button 9 may be a photoelectric sensor.

As mentioned above, according to the present disclosure, a second through hole 1212 is provided in the limit groove 121, and the sensing button 9 is arranged, so that the sensing button 9 can intelligently sense whether the weighing hook 4 swings into the limit groove 121, thereby intelligently identifying a weighing mode and a height ranging mode and automatically switching functions of the portable scale accordingly, which is convenient for a user and improves user experience and use efficiency. Moreover, because the functions are switched based on an actual state of the weighing hook 4, misoperation of a user can be minimized, and reliability and accuracy of the portable scale are further improved. Moreover, the functions are switched intelligently, so that the portable scale can turn off the weighing function when weighing is not needed, thereby reducing energy consumption and achieving the purposes of saving energy and protecting environment. A photoelectric sensor is used as a sensing button 9, which can ensure accuracy and rapidity of sensing. At the same time, the photoelectric sensor itself has the advantages of a small size and a fast response, which further improves flexibility of the portable scale. In addition, the second through hole 1212 is arranged at a position far away from the first through hole 1211, which can prevent the sensing button 9 from detecting the part where the hook is fixedly connected to the housing 1 and mistakenly thinking that the weighing hook 4 has been placed in the limit groove 121, thereby improving sensing accuracy and ensuring accuracy of use of the functions of the portable scale.

As shown in FIG. 1, in a specific implementation, a first PCB (Printed Circuit Board) board 10 is mounted inside the housing 1. A backlight board 13 and a power button 14 which is configured to control the portable scale to be turned on or off are arranged on the first PCB board 10. The backlight board 13 is connected below the display 7. A button protection cover 15 is mounted on the power button 14. The housing 1 is further provided with a third opening 16. A pressing portion 151 of the button protection cover 15 passes through the housing 1 via the third opening 16, so as to be pressed by a human hand from the outside.

As mentioned above, according to the present disclosure, the power button 14 is arranged on the first PCB board 10, so that the user can conveniently control the portable scale to be turned on or off without complex operation. At the same time, the button protection cover 15 is designed to effectively prevent the button from being touched by mistake, which increases durability and stability of the device. The backlight board 13 is connected below the display 7, which can provide backlight illumination in an environment with insufficient light, so that the displayed content is clearly visible, and the visual experience of a user is improved. The pressing portion 151 of the button protection cover 15 passes through the housing 1 via the third opening 16, allowing the user to press from the outside, but preventing foreign objects or water from entering the internal circuit, protecting the internal electronic components from being damaged, and improving the safety of the device. In addition, an integrated design of the first PCB board 10 makes full use of an internal space of the portable scale, and the structure is more compact, which is also convenient for maintenance and upgrading of the device.

As shown in FIG. 3, in a specific implementation, the second opening 6 and the third opening 16 are both provided on an upper surface of the housing 1. The housing 1 extends downwards around the second opening 6 to form an annular wall 17. The housing 1 is provided with a plurality of first mounting posts 18 with screw holes on a periphery of the annular wall 17. The first PCB board 10 is connected to the first mounting posts 18 by a screw. A first reserved space 19 into which the display 7 and the backlight board 13 swing is formed on an inner periphery of the annular wall 17. In this way, the annular wall 17 formed in a manner of extending downwards around the second opening 6 provides a stable mounting structure for the display 7 and the backlight board 13, which not only enhances local strength of the housing 1, but also helps to reduce the damage to internal components due to external impact or vibration. A plurality of first mounting posts 18 with screw holes are arranged on a periphery of the annular wall 17, so that the first PCB board 10 can be conveniently connected to the housing 1 by a screw. The first reserved space 19 is designed to provide a sufficient mounting space for the display 7 and the backlight board 13. The second opening 6 and the third opening 16 are both arranged on an upper surface of the housing 1, so that after the power button 14 in the third opening 16 is pressed, it is more convenient to directly observe whether the display 7 in the second opening 6 on the same plane is powered on.

As shown in FIG. 3, in a specific implementation, a second PCB board 20 and a plurality of second mounting posts 21 with screw holes are arranged in the upper housing portion 11. The wireless ranging sensor 3 is connected to the second PCB board 20. The second PCB board 20 is connected to the second mounting posts 21 by a screw. The plurality of second mounting posts 21 with screw holes are arranged around the first opening 5 and form a second reserved space 22 into which the wireless ranging sensor 3 swings. In this way, a plurality of second mounting posts 21 are arranged around the first opening 5, so that the second PCB board 20 can be conveniently connected to the housing 1 by a screw. The plurality of second mounting posts 21 are designed, so that the second PCB board 20 can be stably mounted on the housing 1, thereby improving stability and reliability of the overall structure. The second reserved space 22 formed around the plurality of second mounting posts 21 provides a suitable placement position for the wireless ranging sensor 3, and is also beneficial to heat dissipation and dust prevention. The second PCB board 20 and the wireless ranging sensor 3 are connected together through modular design, so as to add or remove other functional modules conveniently and expand functions of the device.

As shown in FIG. 1, in a specific implementation, the weighing hook 4 is a metal hook. A second mounting groove 23 is formed outwards on one side wall of the lower housing portion 12, and a first powerful magnet 24 is mounted in the second mounting groove 23. A plurality of third mounting grooves 25 are convexly formed upwards on an inner wall of a bottom surface of the lower housing portion 12, and a second powerful magnet 26 is mounted in the third mounting groove 25. The third mounting groove 25 is located above the upper wall of the limit groove 121. In this way, the first powerful magnet 24 is mounted on the side wall by the second mounting groove 23, allowing the portable scale to be firmly attached to a metal surface, such as a refrigerator door, a metal bracket, etc., thereby enhancing stability in use. The second powerful magnet 26 is mounted on the inner wall of the bottom surface through the third mounting groove 25 and located above the upper wall of the limit groove 121, which can further magnetically attract the weighing hook 4, ensure that the weighing hook 4 may not fall off after being placed in the limit groove 121, improve measurement accuracy during ranging, and enhance user experience.

As shown in FIG. 1 and FIG. 3, in a specific implementation, the housing 1 is further provided with a battery 27, and a power supply port 28 is provided on a side wall of the housing. In a specific implementation, the battery 27 is a rechargeable lithium battery of 3.7 volts. In this way, internal power supply can be achieved by the battery 27, which is portable. Meanwhile, when being insufficient, the battery can be charged through the power supply port 28.

As shown in FIG. 1 and FIG. 3, in a specific implementation, the wireless ranging sensor 3 is an ultrasonic ranging sensor/a radar ranging sensor/an infrared ranging sensor/a laser ranging sensor. In this way, different wireless ranging sensors can be selected according to actual needs, and these sensors have the characteristics of non-contact measurement, which can avoid inconvenience and an error resulted from contact measurement.

As mentioned above, the present disclosure protects a portable scale with a ranging function, and all technical schemes that are the same as or similar to the present disclosure should be shown as falling within the scope of protection of the present disclosure.

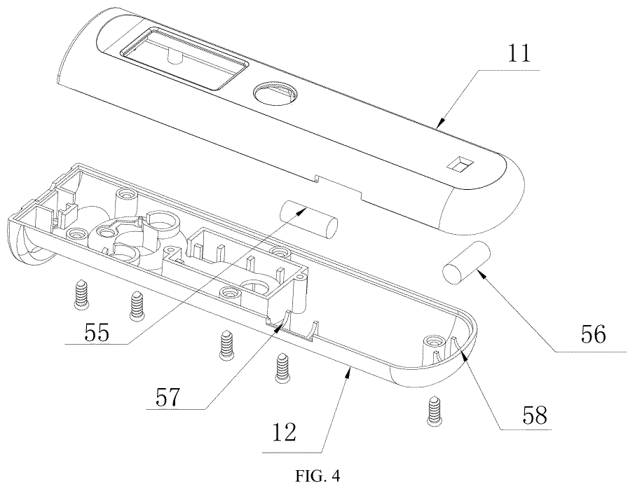

As shown in FIG. 4, at least one group of level meters is mounted at any position outside the housing 1 to assist a user in judging whether the scale is in a horizontal state when using the portable scale, thereby improving accuracy of weighing and ranging. The level meter can be a bubble level meter or other types of electronic level detection modules.

The housing 1 is divided into an upper housing portion 11 and a lower housing portion 12 connected to the upper housing portion 11. The wireless ranging sensor 3 is mounted at a top of the upper housing portion 11. The first opening 5 is provided on an upper surface of the upper housing portion 11. The weighing sensor 2 is mounted at a bottom of the lower housing portion 12. The at least one group of level meters is mounted in a mounting slot between the upper housing portion 11 and the lower housing portion 12, which is convenient for structural integration and achieves a level detection function without increasing an additional volume.

The at least one group of level meters includes a first level meter 55 and a second level meter 56. The mounting slot includes a first mounting slot 57 and a second mounting slot 58 arranged between the upper housing portion 11 and the lower housing portion 12. The first level meter 55 is mounted in the first mounting slot 57. The second level meter 56 is mounted in the second mounting slot 58. The first level meter 55 is arranged perpendicular to the second level meter 56.

With this arrangement, two-way detection of the horizontal state can be achieved, that is, vertical and horizontal directions can be accurately judged at the same time, so that measurement accuracy can be further improved, an error resulted from tilt of the scale can be avoided, and a requirement of an application scenario with higher precision can be met.

The above is only the detailed description of the present disclosure, but the scope of protection of the present disclosure is not limited thereto. Any change or replacement conceivable without creative labor should be included in the scope of protection of the present disclosure. Therefore, the scope of protection of the present disclosure should be based on the scope of protection defined by the claims.

What is claimed is:

1. A portable scale with a ranging function, comprising a housing (1), wherein a weighing sensor (2) and a wireless ranging sensor (3) are arranged on the housing (1), a weighing hook (4) located below the weighing sensor (2) is connected to the housing (1), the housing (1) is provided with a first opening (5) and a second opening (6), the wireless ranging sensor (3) passes through the housing (1) via the first opening (5), a display (7) is mounted on the second opening (6), and at least one group of level meters is mounted at any position outside the housing.

2. The portable scale with the ranging function according to claim 1, wherein the housing (1) is divided into an upper housing portion (11) and a lower housing portion (12) connected to the upper housing portion (11), the wireless ranging sensor (3) is mounted at a top of the upper housing portion (11), the first opening (5) is provided on an upper surface of the upper housing portion (11), the weighing sensor (2) is mounted at a bottom of the lower housing portion (12), and the at least one group of level meters is mounted in a mounting slot between the upper housing portion (11) and the lower housing portion (12).

3. The portable scale with the ranging function according to claim 2, wherein the at least one group of level meters comprises a first level meter (55) and a second level meter (56), the mounting slot comprises a first mounting slot (57) and a second mounting slot (58) arranged between the upper housing portion (11) and the lower housing portion (12), the first level meter (55) is mounted in the first mounting slot (57), the second level meter (56) is mounted in the second mounting slot (58), and the first level meter (55) is arranged perpendicular to the second level meter (56).

4. The portable scale with the ranging function according to claim 2, wherein a limit groove (121) into which the weighing hook (4) swings is concavely arranged upwards on an outer wall of a bottom surface of the lower housing portion (12), a first mounting groove (122) into which the weighing sensor (2) is mounted is convexly formed upwards in the lower housing portion (12), a plurality of limit convex strips (1221) are convexly arranged inwards on an inner wall of the first mounting groove (122), a first through hole (1211) is provided on an upper wall of the limit groove (121), and one end of the weighing hook (4) passes through the first through hole (1211) and is connected to the housing (1) through a nut (8); and
a second through hole (1212) is further provided at a position, far away from the first through hole (1211), of the upper wall of the limit groove (121), a sensing button (9) which is configured to sense whether the weighing hook (4) swings into the limit groove (121) is arranged in the lower housing portion (12), and a sensing portion of the sensing button (9) is mounted at a position of the second through hole (1212).

5. The portable scale with the ranging function according to claim 1, wherein a first PCB (Printed Circuit Board) board (10) is mounted inside the housing (1), a backlight board (13) and a power button (14) which is configured to control the portable scale to be turned on or off are arranged on the first PCB board (10), the backlight board (13) is connected below the display (7), a button protection cover (15) is mounted on the power button (14), the housing (1) is further provided with a third opening (16), and a pressing portion of the button protection cover (15) passes through the housing (1) via the third opening (16).

6. The portable scale with the ranging function according to claim 5, wherein the second opening (6) and the third opening (16) are both provided on an upper surface of the housing (1), the housing (1) extends downwards around the second opening (6) to form an annular wall (17), the housing (1) is provided with a plurality of first mounting posts (18) with screw holes on a periphery of the annular wall (17), the first PCB board (10) is connected to the first mounting posts (18) by a screw, and a first reserved space (19) into which the display (7) and the backlight board (13) swing is formed on an inner periphery of the annular wall (17).

7. The portable scale with the ranging function according to claim 2, wherein a second PCB board (20) and a plurality of second mounting posts (21) with screw holes are arranged in the upper housing portion (11), the wireless ranging sensor (3) is connected to the second PCB board (20), the second PCB board (20) is connected to the second mounting posts (21) by a screw, and the plurality of second mounting posts (21) with screw holes are arranged around the first opening (5) and form a second reserved space (22) into which the wireless ranging sensor (3) swings.

8. The portable scale with the ranging function according to claim 3, wherein a second mounting groove (23) is formed outwards on one side wall of the lower housing portion (12), a first powerful magnet (24) is mounted in the second mounting groove (23), a plurality of third mounting grooves (25) are convexly formed upwards on an inner wall of a bottom surface of the lower housing portion (12), a second powerful magnet (26) is mounted in the third mounting groove (25), and the third mounting groove (25) is located above the upper wall of the limit groove (121).

9. The portable scale with the ranging function according to claim 1, wherein the housing (1) is further provided with a battery (27), and a power supply port (28) is provided on a side wall of the housing.

10. The portable scale with the ranging function according to claim 1, wherein the wireless ranging sensor (3) is an ultrasonic ranging sensor/a radar ranging sensor/an infrared ranging sensor/a laser ranging sensor.
